(19) United States
(12) Patent Application Publication
(10) Pub. No.: US 2024/0424966 A1
(43) Pub. Date: Dec. 26, 2024

(54) ENERGY-ABSORBING INTERIOR IMPACT SURFACE FOR A VEHICLE

(71) Applicant: GM GLOBAL TECHNOLOGY OPERATIONS LLC, DETROIT, MI (US)

(72) Inventors: Neela Praveenkumar, SECUNDERABAD (IN); Rohan G. Raj, Bangalore (IN); Srinivas Surampudi, Bengaluru (IN)

(21) Appl. No.: 18/339,938

(22) Filed: Jun. 22, 2023

(51) Int. Cl. B60N 2/75; B60R 21/04

(52) U.S. Cl. CPC B60N 2/78; B60R 21/0428

(57) ABSTRACT

Embodiments include a vehicle having a door with an interior surface and an armrest disposed on the interior surface of the door. The armrest includes a first material distal from the interior surface of the door, a third material proximal to the interior surface of the door, and a second material disposed in between the first material and the third material. The first material and the third material have a first stiffness and a third stiffness that are both greater than a second stiffness of the second material.

### INTRODUCTION

The disclosure relates to vehicle interiors. More specifically, the disclosure relates to an energy-absorbing impact surface disposed on an interior surface of a vehicle.

Vehicles typically include energy-absorbing impact surfaces. These impact surfaces are safety features that are designed to protect occupants in the event of a collision. In general, such surfaces are typically located on the interior of the vehicle, such as the dashboard, door panels, headliner, center console, center arm rest, or any interior components that interacts with occupant. The purpose of an energy-absorbing impact surface is to reduce the amount of force that is transmitted to the occupants of the vehicle during a collision. When a collision occurs, the impact surface is designed to deform and absorb the energy of the collision, thus reducing the risk of injury to the occupants.

### SUMMARY

In one exemplary embodiment, a vehicle is provided. The vehicle includes a door having an interior surface and an armrest disposed on the interior surface of the door. The armrest includes a first material distal from the interior surface of the door, a third material proximal to the interior surface of the door, and a second material disposed in between the first material and the third material. The first material and the third material have a first stiffness and a third stiffness that are both greater than a second stiffness of the second material.

In addition to the one or more features described herein the armrest has a total width (W_{T}), the first surface has a first width (W₁), the second surface has a second width (W₂), and the third surface has a third width (W₃).

In addition to the one or more features described herein the first width (W₁) is equal to the second width (W₂) and the third width (W₃).

In addition to the one or more features described herein the armrest has a height (H) and wherein the first width (W₁), the second width (W₂), and the third width (W₃) are uniform across the height (H) of the armrest.

In addition to the one or more features described herein the armrest has a height (H) and wherein the first width (W₁), the second width (W₂), and the third width (W₃) are not uniform across the height (H) of the armrest.

In addition to the one or more features described herein the armrest has a length (L) and wherein the first width (W₁), the second width (W₂), and the third width (W₃) are uniform across the length (L) of the armrest.

In addition to the one or more features described herein the armrest has a length (L) and wherein the first width (W₁), the second width (W₂), and the third width (W₃) are not uniform across the length (L) of the armrest.

In addition to the one or more features described herein the first stiffness of the first material and the third stiffness of the third material are at least twice the second stiffness of the second material.

In one exemplary embodiment, a vehicle is provided. The vehicle includes an impact surface disposed on an interior surface of the vehicle. The impact surface configured to impact a user during a collision. The impact surface includes a first material disposed configured to contact the user during the collision, a second material disposed adjacent to the first material, and a third material disposed on an opposing side of the second material from the first material. The first material and the third material have a first stiffness that is greater than a second stiffness of the second material.

In addition to the one or more features described herein the impact surface has a total width (W_{T}), the first surface has a first width (W₁), the second surface has a second width (W₂), and the third surface has a third width (W₃).

In addition to the one or more features described herein the first width (W₁) is equal to the second width (W₂) and the third width (W₃).

In addition to the one or more features described herein the impact surface has a height (H) and wherein the first width (W₁), the second width (W₂), and the third width (W₃) are uniform across the height (H) of the impact surface.

In addition to the one or more features described herein the impact surface has a height (H) and wherein the first width (W₁), the second width (W₂), and the third width (W₃) are not uniform across the height (H) of the impact surface.

In addition to the one or more features described herein the impact surface has a length (L) and wherein the first width (W₁), the second width (W₂), and the third width (W₃) are uniform across the length (L) of the impact surface.

In addition to the one or more features described herein the impact surface has a length (L) and wherein the first width (W₁), the second width (W₂), and the third width (W₃) are not uniform across the length (L) of the impact surface.

In addition to the one or more features described herein the first stiffness of the first material and the third stiffness of the third material are at least twice the second stiffness of the second material.

In one exemplary embodiment, a vehicle is provided. The vehicle includes an impact surface disposed on an interior surface of the vehicle that is configured to impact a user during a collision. The impact surface includes a first material disposed configured to contact the user during the collision, a second material disposed adjacent to the first material, and a third material disposed on an opposing side of the second material from the first material. The first material has a first stiffness, the second material has a second stiffness, and the third material has a third stiffness, and wherein the first stiffness and the third stiffness are greater than the second stiffness. The impact surface has a total width (W_{T}), the first surface has a first width (W₁), the second surface has a second width (W₂), and the third surface has a third width (W₃).

In addition to the one or more features described herein the first stiffness is substantially equal to the third stiffness.

In addition to the one or more features described herein the first stiffness of the first material and the third stiffness of the third material are at least twice the second stiffness of the second material.

In addition to the one or more features described herein the impact surface has a height (H) and wherein the first width (W₁), the second width (W₂), and the third width (W₃) are uniform across the height (H) of the impact surface.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of a vehicle for use in conjunction with one or more embodiments of the present disclosure;

FIG. 2 is a schematic diagram of an interior surface of a door of a vehicle in accordance with an exemplary embodiment of the present disclosure;

FIG. 3 is a schematic diagram of an interior of a vehicle in accordance with an exemplary embodiment of the present disclosure;

FIGS. 4A and 4B are schematic diagrams of an energy-absorbing armrest in accordance with an exemplary embodiment of the present disclosure; and

FIGS. 5A, 5B, 5C, and 5D are cross-sectional views of energy-absorbing interior surfaces in accordance with exemplary embodiments of the present disclosure.

### DETAILED DESCRIPTION

The following description is merely exemplary in nature and is not intended to limit the present disclosure, its application or uses.

Turning now to an overview of the aspects of the disclosure, embodiments of the disclosure include energy-absorbing surfaces that are disposed in the interior of a vehicle. In exemplary embodiments, the energy-absorbing surfaces are made of a first material, a second material, and a third material. The first material is disposed adjacent to the interior of the vehicle, (i.e., the first material will contact the user during the collision), the second material disposed adjacent to the first material, and the third material disposed on an opposing side of the second material from the first material, (i.e., the second material is sandwiched in between the first material and the second material).

In exemplary embodiments, both the first material and the third material have a stiffness that is greater than the stiffness of the second material. As a result, the second material is configured to deform during a collision more easily than the first and third materials, which will result in the energy-absorbing surface absorbing more energy during the collision as compared to a traditional impact surface.

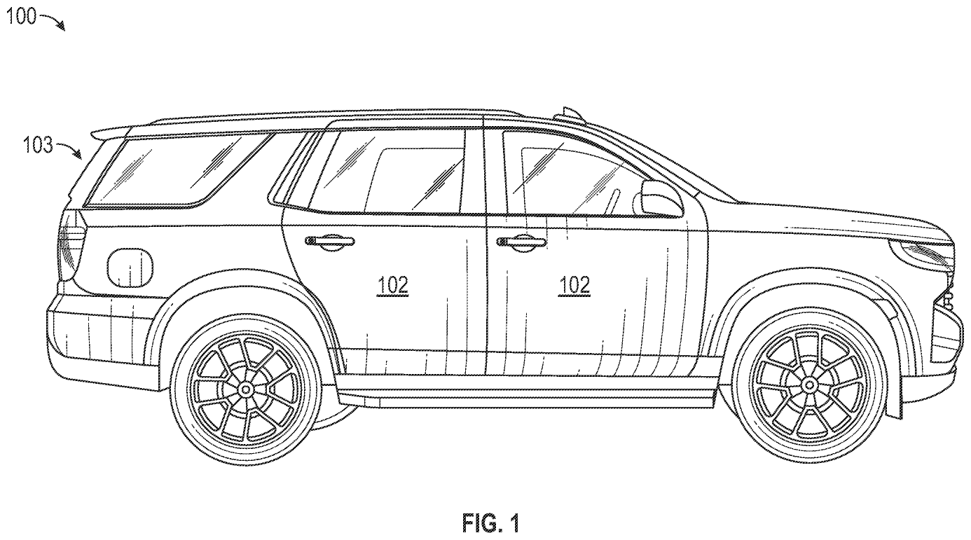

Referring now to FIG. 1, a schematic diagram of a vehicle 100 for use in conjunction with one or more embodiments of the present disclosure is shown. The vehicle 100 includes a plurality of doors 102 that are used for occupant/driver ingress and egress from the vehicle 100. In one embodiment, the vehicle 100 also includes a hatchback 103 that is used to access a storage area of the vehicle 100.

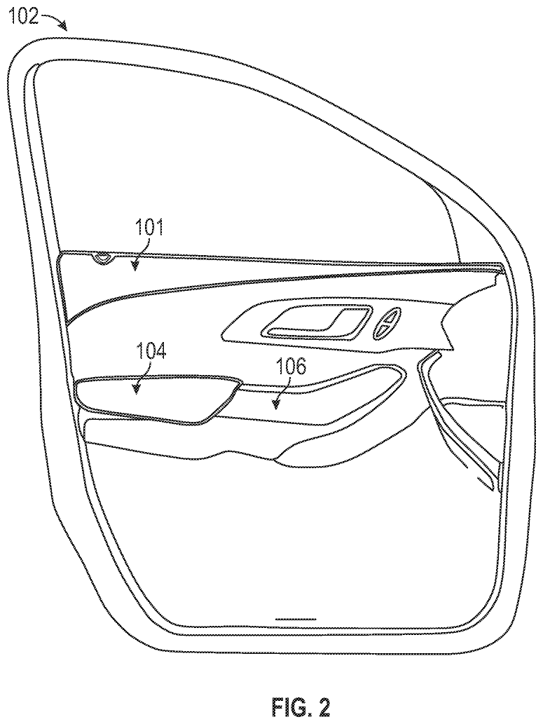

Referring now to FIG. 2, a schematic diagram of an interior surface 101 of a door 102 of a vehicle in accordance with an exemplary embodiment is shown. As illustrated, the interior surface 101 of the door 102 includes an impact surface 104, also referred to herein as an armrest 104. In addition, the interior surface 101 of the door 102 includes a non-impact surface 106, which may be disposed adjacent to the impact surface 104. In exemplary embodiments, the impact surface 104 is a portion of the interior surface 101 of the door 102 that is likely to come into contact with an occupant of the vehicle during a collision. For example, the impact surface 104 may be an armrest that is disposed adjacent to the torso of an occupant of the vehicle.

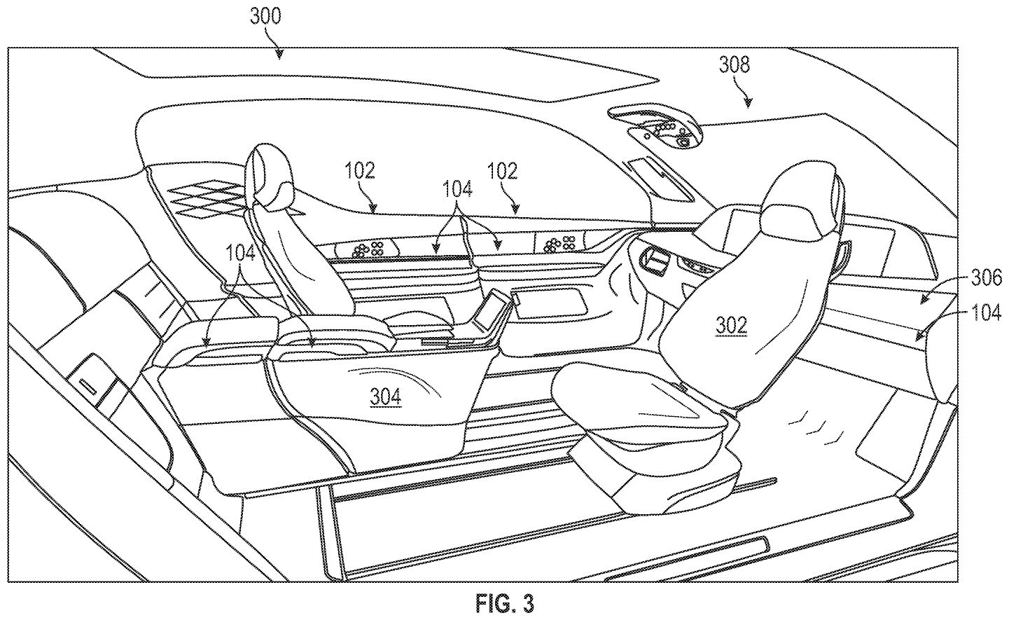

Referring now to FIG. 3 a schematic diagram of an interior 300 of a vehicle in accordance with an exemplary embodiment of the present disclosure is shown. As illustrated, the interior 300 of the vehicle includes one or more seats 302, a center consul 304, a dashboard 306, and a headliner 308. The interior 300 also includes a plurality of impact surfaces 104 that are disposed on one or more of the doors 102, the center consul 304, a dashboard 306, and a headliner 308.

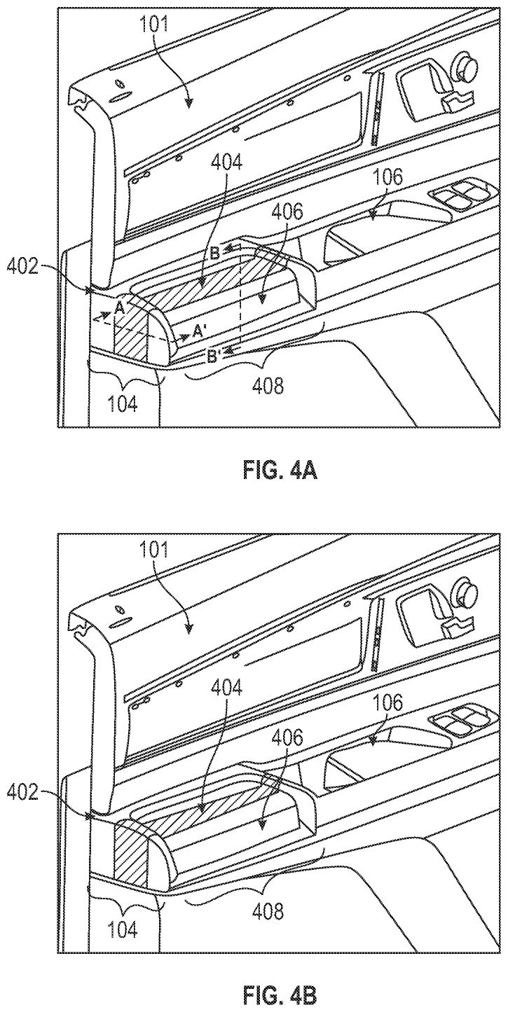

Referring now to FIGS. 4A and 4B, schematic diagrams of an energy-absorbing armrest 104 in accordance with an exemplary embodiment of the present disclosure are shown. As illustrated, the energy-absorbing armrest 104 is disposed on an interior surface 101 of a door of a vehicle. In one embodiment, the energy-absorbing armrest 104 is located adjacent to the torso of an occupant of the vehicle such that during a side-impact collision, the torso of the occupant will impact the energy-absorbing armrest 104. The interior surface 101 of the door also includes a non-impact surface 106 that is disposed in front of the energy-absorbing armrest 104.

As illustrated, the energy-absorbing armrest 104 is made of three materials: a first material 406 that is configured to contact an occupant during the collision; a second material 404 disposed adjacent to the first material; and a third material 402 disposed on an opposing side of the second material 404 from the first material 406. Stated another way, the first material 406 is located distally from the interior surface 101 of the door, the third material 402 is located proximal to the interior surface 101 of the door, and the second material 404 disposed in between the first material 406 and the third material 402. In exemplary embodiments, the energy-absorbing armrest 104 includes a cover (not shown) such as a leather wrapping that covers the surface of the energy-absorbing armrest 104 that comes into contact with the occupant of the vehicle.

In exemplary embodiments, the stiffness (i.e., the extent to which an object resists deformation in response to an applied force) of the second material 404 is less than the stiffness of the first material 406 and the third material 402. In one embodiment, the stiffness of the first material 406 is approximately equal to the stiffness of the third material 402, and the stiffness of the first material 406 and third material 402 are at least twice the second stiffness of the second material 404. In another embodiment, the stiffness of the first material 406 is approximately equal to the stiffness of the third material 402, and the stiffness of the first material 406 and third material 402 are at least four times the second stiffness of the second material 404.

In exemplary embodiments, the energy-absorbing armrest 104 has a length 408 that extends in a direction from the front of the vehicle to the rear of the vehicle. As best shown in FIG. 4A, the first material 406, the second material 404, and the third material 402 may have thicknesses that are substantially constant along the length 408 of the energy-absorbing armrest 104. In addition, the third material 402 may continuous or discontinuous along the length 408 of the energy-absorbing armrest 104.

In other embodiments, as best shown in FIG. 4B, the first material 406, the second material 404, and the third material 402 may have width that vary along the length 408 of the energy-absorbing armrest 104. For example, as shown in FIG. 4B, the width of the second material 404 may decrease from a first width nearest the rear of the vehicle to a second width nearest the front of the vehicle. In exemplary embodiments, the thickness of the second material 404 in a portion of the energy-absorbing armrest 104 is determined based on the likelihood that an occupant will impact that portion of the energy-absorbing armrest 104. In one example, the likelihood that an occupant will impact a portion of the energy-absorbing armrest 104 generally decreases as the portion is located closer to the front of the vehicle.

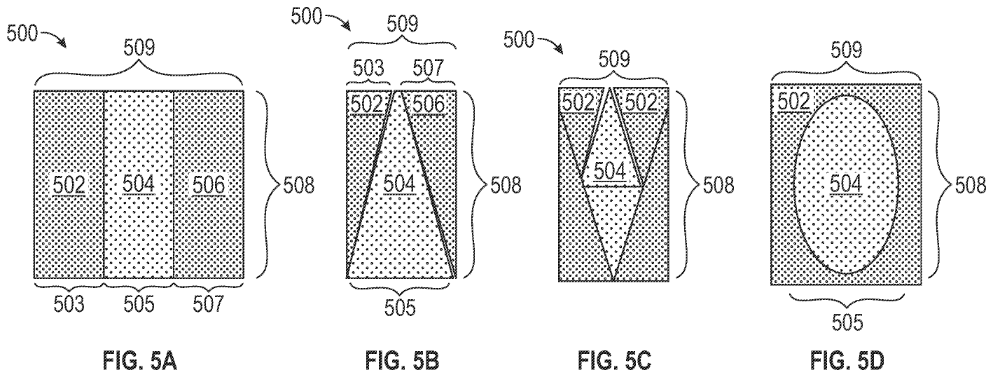

Referring now to FIGS. 5A, 5B, 5C, and 5D, cross-sectional views of energy-absorbing interior surfaces 500 in accordance with exemplary embodiments of the present disclosure are shown. In exemplary embodiments, the cross-sectional view may be taken across either line A-A′ or B-B′ shown in FIG. 4A. The energy-absorbing interior surfaces 500 have a total length 509 and a height 508. In various embodiments, the absorbing interior surfaces 500 are made of one or more materials that have different levels of stiffness. Although four cross-sectional configurations of the energy-absorbing interior surfaces 500 are shown, it will be clear to those of ordinary skill in the art that these configurations are exemplary in nature and that other configurations may be used.

In the embodiment shown in FIG. 5A, the energy-absorbing interior surface 500 includes two exterior portions 502, 506 and a central portion 504 disposed between the exterior portions 502, 506. Each portion 502, 504, and 506 has a corresponding width 503, 505, and 507 that are uniform across the height 508 of the energy-absorbing interior surface 500. In one embodiment, the widths 503, 505, and 507 are approximately equal to one another. In another embodiment, the width 505 of the central portion 504 is approximately twice the widths 507, 507 of the exterior portions 502, 506. In exemplary embodiments, the exterior portions 502, 506 are made of a first material and the central portion 504 is made of a second material and the first material has a first stiffness that is greater than a second stiffness of the second material.

In the embodiment shown in FIG. 5B, the energy-absorbing interior surface 500 includes two exterior portions 502, 506 and a central portion 504 disposed between the exterior portions 502, 506. As illustrated, each portion 502, 504, and 506 has a corresponding width 503, 505, and 507 that vary across the height 508 of the energy-absorbing interior surface 500. In the illustrated embodiment, the widths 503, 507 of the exterior portions 502, 506 decrease linearly from a first end of the energy-absorbing interior surface 500 to a second end of the energy-absorbing interior surface 500. In exemplary embodiments, the exterior portions 502, 506 are made of a first material and the central portion 504 is made of a second material and the first material has a first stiffness that is greater than the second stiffness of the second material.

In the embodiment shown in FIG. 5C, the energy-absorbing interior surface 500 includes two exterior portions 502, 506 and a central portion 504 disposed between the exterior portions 502, 506. As illustrated, each portion 502, 504, and 506 has a corresponding width 503, 505, and 507 that vary across the height 508 of the energy-absorbing interior surface 500. In the illustrated embodiment, the widths 503, 507 of the exterior portions 502, 506 decrease linearly from the ends of the energy-absorbing interior surface 500 to a central part of the energy-absorbing interior surface 500. In exemplary embodiments, the exterior portions 502, 506 are made of a first material and the central portion 504 is made of a second material and the first material has a first stiffness that is greater than the second stiffness of the second material.

In the embodiment shown in FIG. 5D, the energy-absorbing interior surface 500 includes an exterior portion 502 and a central portion 504. In the illustrated embodiment, the width 505 of the central portion 504 generally increases from the ends of the energy-absorbing interior surface 500 to a central part of the energy-absorbing interior surface 500. In exemplary embodiments, the exterior portion 502 is made of a first material and the central portion 504 is made of a second material and the first material has a first stiffness that is greater than the second stiffness of the second material.

First and third material can take all grades of plastic and second material can take all grades of soft plastic/rubber/foam/or any other deformable material. Some of the examples of first and third material include high density materials of polypropylene (PP), polycarbonate (PC), polyethylene (PE), and the like. Second material can take all types of EPDM with Polypropylene (PP), TPU, TPV, TPC, and the like.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising
a door having an interior surface; and
an armrest disposed on the interior surface of the door, the armrest comprising a first material distal from the interior surface of the door, a third material proximal to the interior surface of the door, and a second material disposed in between the first material and the third material,
wherein the first material and the third material have a first stiffness and a third stiffness that are both greater than a second stiffness of the second material.

2. The vehicle of claim 1, wherein the armrest has a total width (W_{T}), the first material has a first width (W₁), the second material has a second width (W₂), and the third material has a third width (W₃).

3. The vehicle of claim 2, wherein the first width (W₁) is equal to the second width (W₂) and the third width (W₃).

4. The vehicle of claim 2, wherein the armrest has a height (H) and wherein the first width (W₁), the second width (W₂), and the third width (W₃) are uniform across the height (H) of the armrest.

5. The vehicle of claim 2, wherein the armrest has a height (H) and wherein the first width (W₁), the second width (W₂), and the third width (W₃) are not uniform across the height (H) of the armrest.

6. The vehicle of claim 2, wherein the armrest has a length (L) and wherein the first width (W₁), the second width (W₂), and the third width (W₃) are uniform across the length (L) of the armrest.

7. The vehicle of claim 2, wherein the armrest has a length (L) and wherein the first width (W₁), the second width (W₂), and the third width (W₃) are not uniform across the length (L) of the armrest.

8. The vehicle of claim 1, wherein the first stiffness of the first material and the third stiffness of the third material are at least twice the second stiffness of the second material.

9. A vehicle comprising
an impact surface disposed on an interior surface of the vehicle, the impact surface configured to impact a user during a collision, the impact surface comprising a first material disposed configured to contact the user during the collision, a second material disposed adjacent to the first material, and a third material disposed on an opposing side of the second material from the first material,
wherein the first material and the third material have a first stiffness that is greater than a second stiffness of the second material.

10. The vehicle of claim 9, wherein the impact surface has a total width (W_{T}), the first material has a first width (W₁), the second material has a second width (W₂), and the third material has a third width (W₃).

11. The vehicle of claim 10, wherein the first width (W₁) is equal to the second width (W₂) and the third width (W₃).

12. The vehicle of claim 10, wherein the impact surface has a height (H) and wherein the first width (W₁), the second width (W₂), and the third width (W₃) are uniform across the height (H) of the impact surface.

13. The vehicle of claim 10, wherein the impact surface has a height (H) and wherein the first width (W₁), the second width (W₂), and the third width (W₃) are not uniform across the height (H) of the impact surface.

14. The vehicle of claim 10, wherein the impact surface has a length (L) and wherein the first width (W₁), the second width (W₂), and the third width (W₃) are uniform across the length (L) of the impact surface.

15. The vehicle of claim 10, wherein the impact surface has a length (L) and wherein the first width (W₁), the second width (W₂), and the third width (W₃) are not uniform across the length (L) of the impact surface.

16. The vehicle of claim 9, wherein the first stiffness of the first material and the third material are at least twice the second stiffness of the second material.

17. A vehicle comprising
an impact surface disposed on an interior surface of the vehicle, the impact surface configured to impact a user during a collision, the impact surface comprising a first material disposed configured to contact the user during the collision, a second material disposed adjacent to the first material, and a third material disposed on an opposing side of the second material from the first material,
wherein the first material has a first stiffness, the second material has a second stiffness, and the third material has a third stiffness, and wherein the first stiffness and the third stiffness are greater than the second stiffness, and
wherein the impact surface has a total width (W_{T}), the first material has a first width (W₁), the second material has a second width (W₂), and the third material has a third width (W₃).

18. The vehicle of claim 17, wherein the first stiffness is substantially equal to the third stiffness.

19. The vehicle of claim 17, wherein the first stiffness of the first material and the third stiffness of the third material are at least twice the second stiffness of the second material.

20. The vehicle of claim 17, wherein the impact surface has a height (H) and wherein the first width (W₁), the second width (W₂), and the third width (W₃) are uniform across the height (H) of the impact surface.
